(19) United States
(12) Patent Application Publication
(10) Pub. No.: US 2004/0189491 A1
(43) Pub. Date: Sep. 30, 2004

(54) Traffic light displaying remaining time

(76) Inventor: Muhitdin Orhan Aydin, Ankara (TR)

Correspondence Address: Collen Ip, The Holyoke Manhattan Building, 80 South Highland Avenue, Ossining, NY, 10562-5615, US

(21) Appl. No.: 10/484,185

(22) PCT Filed: Jun. 11, 2002
(86) PCT No.: PCT/TR02/00021

(30) Foreign Application Priority Data
Jul. 16, 2001 (TR) 01/02051

(51) Int. Cl. G08G 1/07

(52) U.S. Cl. 340/925

(57) ABSTRACT

A traffic light displaying remaining time on itself is developed with this invention characterized by a numerical display of the remaining time on the light, in which a traffic light and a backwards counter is combined within the same unit, and if necessary, in which data is not received with or without a cable from anywhere including the junction control device to which it is connected, which can be placed in the spot of the current signal transmitter light, in which the sizes, colours, digit forms and number of digits may be altered, which consists of various number of light sources where the size of the numbers can be fitted in the standard signal transmitters and can be easily read, and which can be controlled by a micro computerized electronic circuit.

This invention concerns an electronic traffic light, which displays the remaining time of the lights, as well as informing the drivers and pedestrians by red, yellow and green lights. The remaining time counters, which count the remaining time backwards, are with and integrated in the traffic signal lights developed in line with this invention, and it has been provided that such lights work without any additional costs or effort and when necessary independent of the junction control device.

Traffic management has gained increasing importance in the heavy traffic load of our day. Technological developments pave the way for new arrangements to be made in this sector. Traffic lights (traffic signal transmitters) are used for the management of traffic all around the world. Red, yellow and green lights bear the same meaning throughout the world for all people.

Filament or halogenous lamps have been used in the traffic lights as a light source for many years. There is low efficiency in the conversion of energy into light in such traffic lights. Such lights convert some part of the energy they use into heat and their lives vary from a thousand hours to five thousand hours. The developments in semi-conductor technology have turned LED (Light Emitting Diode) technology into an alternative light source. Traffic lights with LED, which save up to 70-80% of energy, and whose minimum life is 100 times of that of the filament lights, have come to be used throughout the world in the recent years. The utilization rate of traffic lights with LED is gradually increasing since the only disadvantageous factor, the investment cost of these lights, is also gradually improving.

Another technological development in traffic management is the electronic time counter, which counts back and displays numerically the remaining time of the red and/or green light, i.e. how much time is remaining for the next light to flash in seconds. Such counter devices use LED as light source. In the current application, these time counters, which display the remaining time, are added under the existing three lamps in the traffic lights (the traffic light set) as a fourth unit. However adding these counters under the existing traffic light set causes some problems since these are not located high enough. Adding these counters above the traffic light set is also problematic due to the insufficient height of the poles, and an additional portion is required for such applications. There exists a patent No. TR 1998 00723 B for such applications.

We have found in the studies that we have conducted on the traffic lights with remaining time display that there is a US Pat. No. 5,519,390 on this issue. The patent, the application of which was made on Feb. 2, 1995, defines a traffic light with a graphical or an alphanumerical display unit. In the graphical display type of this unit, which is the subject of that invention, either images (forms) such as a walking pedestrian or a still pedestrian, or inscriptions such as WALK and STOP are called from the memory to the display unit and displayed. It was further noted that the display generator is programmable. In the traffic lights defined by this patent the remaining time and the images (forms) are displayed separately from the lights. The system targets the pedestrians.

In the German patent published with DE 42 10 996 A1 number, the application of which was made on Apr. 2, 1992, there is a traffic light with a fixed time command, and a method developed for showing the remaining time of the current circuit is described. The method described in the patent concerns the working principle of a counter unit; microprocessor technology is not used.

In the Russian patent published with 726564 number, the application of which was made on Nov. 1, 1974, there is the definition of a traffic light whose informational capacity was increased by 4 signal regulators and consisting of warning lights connected to the commutator outlet, an alternative voltage source and a voltage block. The system does not make use of the microprocessor technology.

In the French patent published with 86 02453 number, the application of which was made on Feb. 19, 1986, there is the definition of a single digit additional display unit located above the green light, which counts back the last 9 seconds.

In t he U.S. Pat. No. 5,726,648 published with 2-594-577 number and the application of which was made on Oct. 12, 1996, there is the definition of a traffic light consisting of display units with two circular lights of “stop -red” and “warning-yellow” above seven rectangular “walk-green” displays and a time display under those.

In the U.S. Pat. No. 6,175,313, the application of which was made on Apr. 28, 1999, there is the definition of a remaining time display unit in the form of an hourglass mounted to one side of the conventional traffic lights.

As for the traffic light displaying remaining time on itself, which is the subject of this invention, the counters, which count back the remaining time of the lights, are located within the lights and are integrated in the lights, thereby working with no additional cost or effort and independently of the junction control device when necessary.

The illustrations for a better understanding of how the traffic light displaying remaining time on itself works is attached herein. The definitions for the illustrations are as follows:

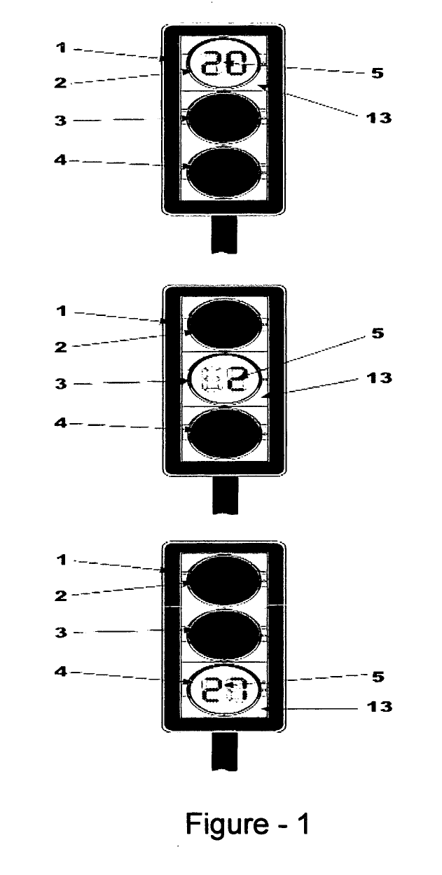

FIG. 1—Group of traffic lights with remaining time display (three different illustrations)

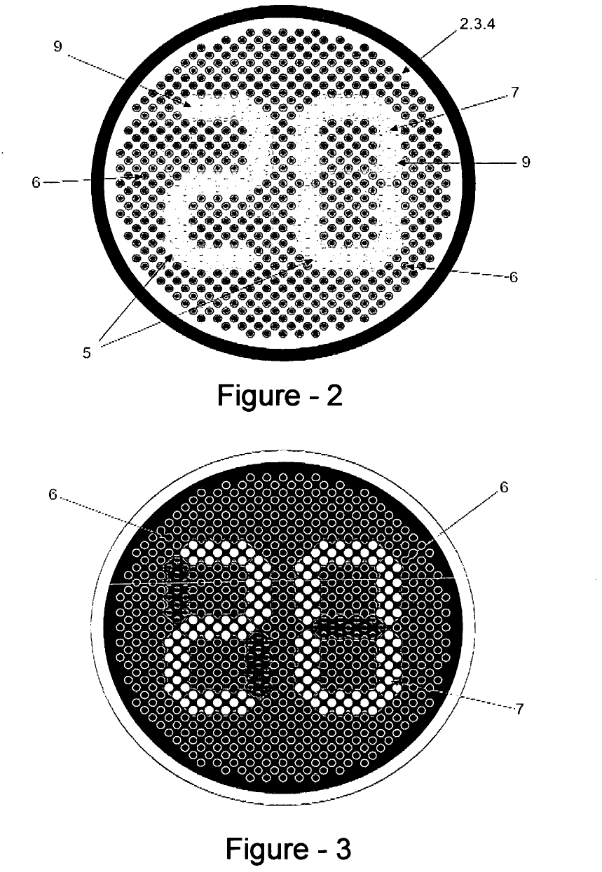

FIG. 2—Sample display with same traffic lights and segment colours

FIG. 3—Sample display with different traffic lights and segment colours

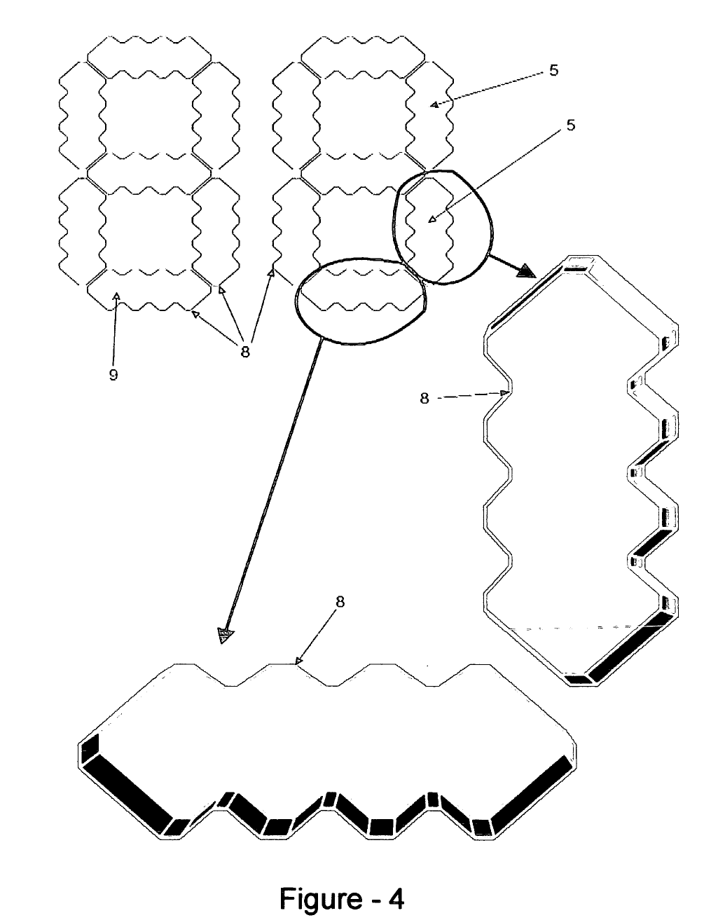

FIG. 4—Overall segment shade and exposed perspective

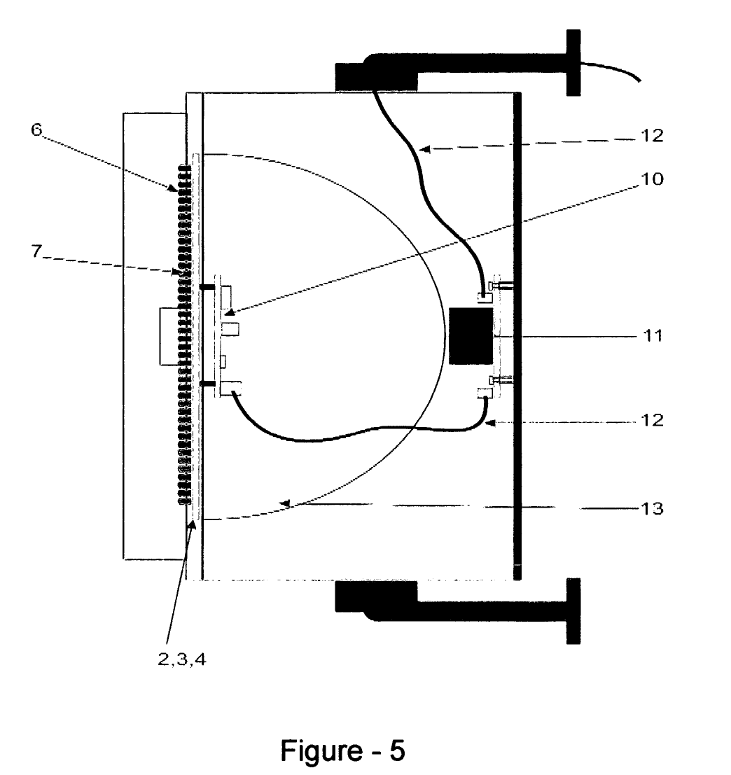

FIG. 5—Internal view of the traffic light

For a better understanding of how the traffic light displaying remaining time on itself works, the parts shown in the illustrations are given numbers. The list of these parts is as follows:

1—Lights group

2—Red lights

3—Yellow lights

4—Green lights

5—Remaining time display (Backwards counter)

6—Lamp light member

7—Remaining time display light member

8—Segment shade

9—Segment

10—Control unit (circuit)

11—Transformator (transformer)

12—Electrical connection cable

13—Body

The light display member (preferably LED or a light source with display members with magnetic flap) (6 and 7), the traffic lights and counter (5) applications are combined in a single unit in the traffic lights with remaining time display, which is the subject of this invention. Therefore, without adding an additional part to the current traffic lights group (1) or the pole, a traffic lights unit (2, 3 and 4) with light display member (preferably LED or a display member with magnetic flap) (6 and 7) is mounted instead of a filament or halogenous lamp, and both the lights (2, 3 and 7) and the counter (5) are used together. If any information on time is received from the junction control device, this information is received and displayed directly; however, if no such information is received the remaining time for the lamps is displayed without using any data cable or an extra cable. For this reason, it can be applied for all types and brands of junction control devices.

In the traffic light displaying remaining time on itself, which is the subject of this invention, lamps (preferably LED or a display member with magnetic flap) (6 and 7) are used as light sources. Light sources may come in various cases. Round LEDs of 5mm diameter are preferred since these are the most appropriate and the most commonly used in traffic management. It is possible to use LEDs of different sizes, or similar light sources. The traffic lights, which are round with a diameter of 200 or 300 mm, have become the standard all around the world and are used widely. In order to provide sufficient light and in order to be easily read, a sufficient number of light sources (preferably LEDs) (6) of desired sizes are placed in the area of a lamp of 200 or 300 mm diameter. Each segment of the display parts in this area required for displaying a minimum of 2-digit figures are controlled by a micro computerized electronic card or another electronic circuit. The light sources (7) in the controlled segments display numbers by extinguishing necessary segments (9) if the light segments are the same colour with the traffic lights. If the colours of the light sources (7) in the controlled segments are different from that of the main light, the number is displayed by lighting the segments (9). Furthermore, by preventing the permanent light sources (6) in the lamp section to emit light to the extinguished segments (9), shades (8), which do not block the view, are applied in order to increase the visibility of the numbers.

The traffic light displaying remaining time on itself, which is the subject of this invention, consists of two parts. One is the micro computerized electronic control circuit (10) and the other is the lamp display with light source (2, 3 and 4). The micro computerized electronic control circuit (10) is uniform and independent of the size of the lights (2, 3, and 4); however the sizes of the display with light source, main colour and segment (9) colours, number forms and the number of LEDs used may vary. Light source display is physically one piece, but electronically consists of two parts. The first part is used as the traffic light, which is turned on as the device is given energy, and which remains on until the energy is halted. The second part is the number (5) which shows the remaining time through a micro computerized electronic control circuit (10) when the device is energized. Displays of various numbers of segments (9) consisting of two digits are used in this device for showing the figures. The sizes of the numbers are so chosen that they can be fitted in the standard signal transmitters and that they can be easily read.

Micro computerized electronic control circuit (10) is placed anywhere that is appropriate behind the light unit. The electricity of the circuit (10) is provided from the transformer of the light if available, and if not available from a transformer (11) placed at an appropriate area within the body (13) via a connection cable (12). If there is not enough space within the body (13) of the light, the transformer (11 ) and the control circuit (10) may be placed outside the light in an appropriate container box.

The traffic light displaying remaining time on itself, which is the subject of this invention, may be manufactured independently without being placed in the spot of a current electric light. If this shall be the case, the appearance of the traffic light displaying remaining time on itself may be altered during

1.- A traffic light displaying remaining time on itself characterized by a numerical display of the remaining time in seconds on the light, in which a traffic light and a backwards counter is combined within the same unit as integrated with the light, and if necessary, in which data is not received with or without a cable from anywhere including the junction control device to which it is connected, which can be placed in the spot of the current signal transmitter light, in which the sizes, colors, digit forms and number of digits may be altered, which consists of various number of light sources which are preferably LED or a display member with a magnetic flap where the size of the numbers showing the remaining time in seconds can be fitted in the standard signal transmitters and can be easily read, and which can be controlled by a micro computerized electronic circuit and can be mounted directly to the current traffic light group or pole without adding any additional part.

2.- Traffic light displaying remaining time on itself as shown in claim 1 and characterized by direct display of the time information if such information is transmitted from the junction control device; direct display of the light time on its own without using any data cable or additional cable if such information is not transmitted.

3.- Traffic light displaying remaining time on itself as shown in claims 1 and 2 and characterized by light sources having different cases.

4.- Traffic light displaying remaining time on itself as shown in claims 1, 2 or 3 and characterized by placing in sufficient numbers on the light surface to provide sufficient light from the light sources in desired size.

5.- Traffic light displaying remaining time on itself as shown in claims 1, 2, 3 or 4 and characterized by micro computed controlled units controlling segments which are necessary to display 1-digit, preferably, 2-digit figures.

6.- Traffic light displaying remaining time on itself as shown in claims 1, 2, 3, 4 or 5 and characterized by segments of light sources in the controlled segments displaying figures by turning it off if it is in the same colour with the traffic light.

7.- Traffic light displaying remaining time on itself as shown in claims 1, 2, 3, 4, 5 or 6 and characterized by segments of light sources in the controlled segments displaying figures by turning it on if it is not in the same colour with the traffic light.

8.- Traffic light displaying remaining time on itself as shown in claims 1, 2, 3, 4, 5, 6 or 7 and characterized by the application of shadows around the segments in a way which will not affect the general appearance by the continuously flashing light sources on the surface of the light preventing light being dispersed to the segments which will not be on.

9.- Traffic light displaying remaining time on itself as shown in claims 1, 2, 3, 4, 5, 6, 7 or 8 and characterized by a single-type of micro computed electronic control circuit independent of the size of the light and adjustable light source indicator size, main colour and segment colour, figure shapes and number of light sources used.

10.- Traffic light displaying remaining time on itself as shown in claims 1, 2, 3, 4, 5, 6, 7, 8 or 9 and characterized by the light source indicator consisting of one part physically and two parts electronically.

11.- Traffic light displaying remaining time on itself as shown in claims 1, 2, 3, 4, 5, 6, 7, 8, 9 or 10 and characterized by the first part of the light source indicator being the part which is used as the traffic light and is on when the device is powered and which continues to be on until the power is interrupted.

12.- Traffic light displaying remaining time on itself as shown in claims 1, 2, 3, 4, 5, 6, 7, 8, 9, 10 or 11 and characterized by the second part being the figure segment which is controlled by the micro computed electronic circuit when the device is powered and which shows the time for which the light will be on.

13.- Traffic light displaying remaining time on itself as shown in claims 1, 2, 3, 4, 5, 6, 7, 8, 9, 10, 11 or 12 and characterized by the second part which displays figures consisting of at least 1-digit, preferably, 2-digit segments in different numbers and the size of figures being easily fit into the signal transmitters and in a size which is easily legible.

14.- Traffic light displaying remaining time on itself as shown in claims 1, 2, 3, 4, 5, 6, 7, 8, 9, 10, 11, 12 or 13 and characterized by the placement of micro computed electronic control circuit at a suitable location right behind the light unit.

15.- Traffic light displaying remaining time on itself as shown in claims 1, 2, 3, 4, 5, 6, 7, 8, 9, 10, 11, 12, 13 or 14 and characterized by the provision of electricity to the micro computed electronic control circuit from the transformer of the light, if there is any, and if no, from the transformer which is placed in a suitable location in the light body by means of a connection cable.

16.- Traffic light displaying remaining time on itself as shown in claims 1, 2, 3, 4, 5, 6, 7, 8, 9, 10, 11, 12, 13, 14 or 15 and characterized by the placement of the transformer and control circuit in a box outside the light if there is not enough room in the light body.

17.- Traffic light displaying remaining time on itself as shown in claims 1, 2, 3, 4, 5, 6, 7, 8, 9, 10, 11, 12, 13, 14, 15 or 16 and characterized by the colour of the traffic light and the colour of light sources of the countdown figures being the same or opposite.

18.- Traffic light displaying remaining time on itself as shown in claims 1, 2, 3, 4, 5, 6, 7, 8, 9, 10, 11, 12, 13, 14, 15, 16 or 17 and characterized by the production of the traffic light in different colours, sizes and appearances independently without replacing an existing traffic light.
